(19) United States
(12) Patent Application Publication
(10) Pub. No.: US 2026/0029604 A1
(43) Pub. Date: Jan. 29, 2026

(54) METHODS AND SYSTEMS FOR FIBER CAN OPTIMIZATION AND PATCHING HARDWARE IN ACTIVE RACKS WITH CABLE ROUTING AND CABLE MANAGEMENT FUNCTIONS

(71) Applicant: META PLATFORMS, INC., Menlo Park, CA (US)

(72) Inventor: Hao-Yun Ma, San Jose, CA (US)

(21) Appl. No.: 19/086,886

(22) Filed: Mar. 21, 2025

Related U.S. Application Data
(60) Provisional application No. 63/676,482, filed on Jul. 29, 2024.

(51) Int. Cl. G02B 6/44

(52) U.S. Cl. CPC G02B 6/44526; G02B 6/4446; G02B 6/44515; G02B 6/44528

(57) ABSTRACT

Various systems are described regarding fiber cans to accept cables and are mountable in racks. The fiber can may include a patching compartment and a cable management compartment. The fiber can is configured such that optical cables are accessible from a front side of a rack. The patching compartment includes a front panel. The front panel may be a patching panel including FAP panels, a FAP panel holder, and adapters associated with one or more of the FAP panels. The front panel may be flipped down such that the back of the patching panel is observable, and a second set of optical cables may be manageable. The patching compartment may include a cable drop-off window and a rounded edge to pass the second set of optical cables to the cable management compartment. The cable management compartment may direct/guide the second set of optical cables to the front of the rack.

### CROSS-REFERENCE TO RELATED APPLICATIONS

This application claims priority to U.S. Provisional Application No. 63/676,482, filed Jul. 29, 2024, entitled “Fiber Can Optimization, A Patching Hardware In Active Rack With Cable Routing And Cable Management Functions,” the contents of which is incorporated by reference herein in its entirety.

### TECHNOLOGICAL FIELD

The present disclosure generally relates to methods and designs for a unique construction for a patch panel assembly.

### BACKGROUND

The use of racks has become an integral part of server room operation. Fiber cans (e.g., a patch panel assembly) may serve as home to many cables, and a patch panel. These cables may be tangled and may be strained due to the dense population of cables in a small space. Damage to these cables may be destructive to the overall efficiency of servers and may leave users, companies, etc. open to a risk of data loss and overheating.

### BRIEF SUMMARY

Various systems, methods, and/or devices are described for a fiber can that may allow for a user to interact with a number/plurality of optical cables on a front side of a rack.

In various examples, systems and devices for a fiber can configured to accept a plurality of cables are provided. The fiber can may be mountable in racks (e.g., existing racks, new racks, etc.). The fiber can may include a patching compartment and a cable management compartment. The fiber can may be configured such that a plurality of optical cables may be accessible from a front side of a rack. The patching compartment may include a front panel. The front panel may be a patching panel including a plurality of fiber access point (FAP) panels, a FAP panel holder, and a plurality of adapters (e.g., one-port adapters, two-port adapters, four-port adapters, or any combination thereof) associated with a FAP panel of the plurality of FAP panels. The front panel may be flipped down such that the back of the patching panel may be observed and a second set of optical cables may be managed with ease. The patching compartment may include a cable drop-off window and a rounded edge to pass the second set of optical cables to the cable management compartment. The cable management compartment may direct or guide the second set of optical cables back to the front of the rack.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The summary, as well as the following detailed description, is further understood when read in conjunction with the appended drawings. For the purpose of illustrating the disclosed subject matter, there are shown in the drawings examples of the disclosed subject matter; however, the disclosed subject matter is not limited to the specific methods, compositions, and devices disclosed. In addition, the drawings are not necessarily drawn to scale. In the drawings:

FIG. 1 illustrates an example cross sectional view of a server rack, in accordance with an example of the present disclosure.

FIG. 2A illustrates an example perspective view of a fiber can, in accordance with an example of the present disclosure.

FIG. 2B illustrates example nomenclature associated with the elements of the fiber can, in accordance with an example of the present disclosure.

FIG. 2C illustrates alternate examples of fiber can compartments, in accordance with an example of the present disclosure.

FIG. 3A illustrates example dimensions associated with a fiber can, in accordance with an example of the present disclosure.

FIG. 3B illustrates example dimensions associated with a fiber can, in accordance with an example of the present disclosure.

FIG. 4A illustrates a fiber can focusing on a section of a fiber access point panel, in accordance with an example of the present disclosure.

FIG. 4B illustrates an example fiber access point panel, in accordance with an example of the present disclosure.

FIG. 4C illustrates example fiber access point panel nomenclature, in accordance with an example of the present disclosure.

FIG. 4D illustrates an example detailed view of a fiber access point panel, in accordance with an example of the present disclosure.

FIG. 4E illustrates an example dimensions of a fiber access point panel, in accordance with an example of the present disclosure.

FIG. 5 illustrates an example fiber access point panel comprising an example port 1 location and MMC adapter marking orientation, in accordance with an example of the present disclosure.

FIG. 6A illustrates an example fiber can patching compartment, in accordance with an example of the present disclosure.

FIG. 6B illustrates example dimensions of a patching compartment, in accordance with an example of the present disclosure.

FIG. 6C illustrates a cross sectional view of a front end of a patching compartment, in accordance with an example of the present disclosure.

FIG. 6D illustrates a front panel, associated with the patching compartment of a fiber can, in accordance with an example of the present disclosure.

FIG. 6E illustrates a function of a front panel associated with the patching compartment of a fiber can, in accordance with an example of the present disclosure.

FIG. 6F illustrates a function of a front panel associated with the patching compartment of a fiber can, in accordance with an example of the present disclosure.

FIG. 7A illustrates a cross sectional side view of a fiber can illustrating an example operation method of a patching compartment, in accordance with an example of the present disclosure.

FIG. 7B illustrates a cross sectional side view of a fiber can illustrating an example operation method of a patching compartment, in accordance with an example of the present disclosure.

FIG. 8A illustrates example dimensions of a cable management compartment associated with a cross sectional side view of a fiber can, in accordance with an example of the present disclosure.

FIG. 8B illustrates an example front of a cable management compartment, in accordance with an example of the present disclosure.

FIG. 9A illustrates an example cable installation and positioning in a cable management compartment of a fiber can, in accordance with an example of the present disclosure.

FIG. 9B illustrates example cable management features associated with a cable management compartment of a fiber can, in accordance with an example of the present disclosure.

FIG. 9C illustrates example cable management features associated with a cable management compartment of a fiber can, in accordance with an example of the present disclosure.

FIG. 10 illustrates an example backdoor associated with a fiber can, in accordance with an example of the present disclosure.

The figures depict various examples for purposes of illustration only. One skilled in the art will readily recognize from the following discussion that alternative examples of the structures and methods illustrated herein may be employed without departing from the principles described herein.

### DETAILED DESCRIPTION

Some examples of the present invention will now be described more fully hereinafter with reference to the accompanying drawings, in which some, but not all examples of the invention are shown. Indeed, various examples of the invention may be embodied in many different forms and should not be construed as limited to the examples set forth herein. Like reference numerals refer to like elements throughout. As used herein, the terms “data,” “content,” “information” and similar terms may be used interchangeably to refer to data capable of being transmitted, received or stored in accordance with examples of the invention. Moreover, the term “exemplary”, as used herein, is not provided to convey any qualitative assessment, but instead merely to convey an illustration of an example. Thus, use of any such terms should not be taken to limit the spirit and scope of examples of the invention.

The use of racks has become an integral part of server room operation. Fiber cans serve as home to many cables, and a patch panel. These cables may be tangled and strained due to the dense population of cables in a small space. Damage to these cables may be destructive to the overall efficiency of servers and leave users, companies, etc. open to a risk of data loss and overheating. Conventionally, patch panels allow for access to optical cables on the front side of a rack and optical cables on the back side of a rack. Usually a patch panel may be configured to allow optical cables to be patched at different sides of a passive rack, then manage cables at different side of the patch panel. This orientation may take up more space in already limited space in datacenters. Further in some implementations, this may also lead to a less efficient use of servers, due to the fact that there may need to be a passive rack and an active rack in many conventional racks. In an active rack, back side of patch panel is usually taken up by hot aisle containment systems (HAC) or power module/strip. Passive racks typically house patch panels but do not comprise switches or other equipment. Active racks may comprise switches or other equipment but lack patch panels. In many instances, service to an active rack may be dangerous due to the heat associated with the back of racks.

As such, there may be a need for a system and/or a method to combine passive and active racks such that there may be more space available in datacenters, which may allow for more racks and a more efficient or powerful data server. There may also be a need for a fiber can or a patch panel assembly that may allow for management of cables on a front side associated with a server rack.

As disclosed herein, systems and methods for a patch panel system (e.g., fiber can) that may allow for cable dressing or management on the front side of a server rack. The fiber can may include a cable management compartment that may route cables from the back of an adapter to the front side of a server rack. Further with the ability of cable management from the front of the rack it may be possible to combine passive and active racks to save space in datacenters.

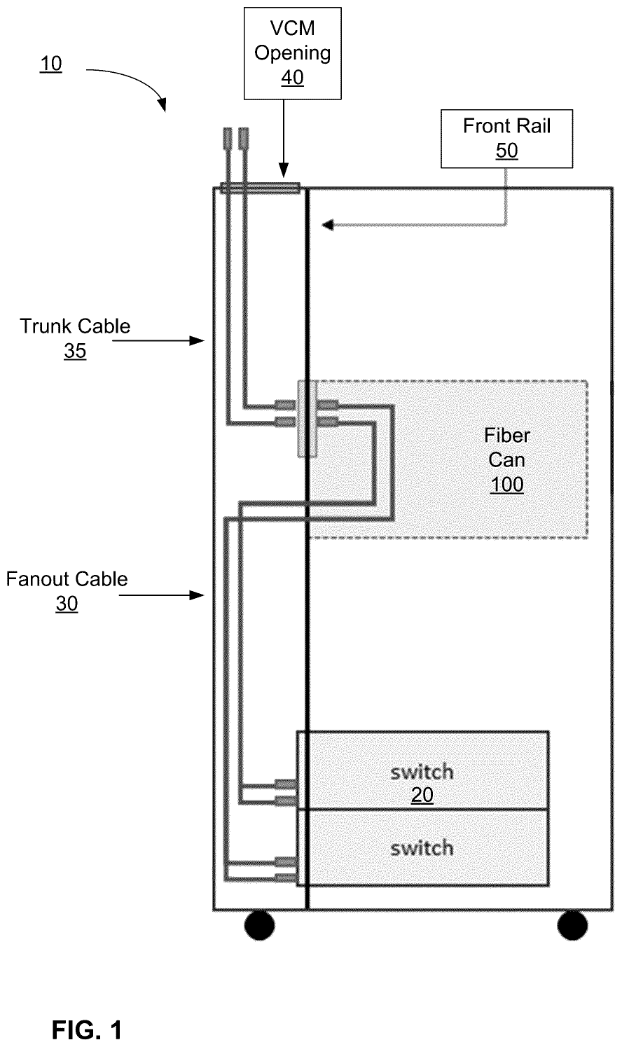

FIG. 1 illustrates an example cross-sectional view of a rack 10, in accordance with an example of the present disclosure. The cross-sectional view of rack 10 may be positioned such that the front of the rack may be associated with the left side of FIG. 1. The rack 10 may comprise a fiber can 100, one or more switches 20, a VCM opening 40, and optical cables to and from fiber can 100. Optical cables to the fiber can 100 may be considered a first set of optical cables 35 and optical cables from the fiber can 100 may be consider a second set of optical cables 30. The optical cables (e.g., the first set of optical cables 35 and the second set of optical cables 30) may interact to transmit data, power, or the any other suitable media via a patch panel associated with the fiber can 100. In an example, the patch panel may be configured to create connections between a number of optical cables, e.g., creating a connection at which data may be transferred between the first set of optical cables 35 and the second set of optical cables 30. Fiber can 100 may be configured to house a connector module (e.g., patch panel) to join together cables necessary to transfer data. The rack 10 may include rails, for purpose of illustration, and not of limitation, a front rail 50 may be shown in FIG. 1. The rails (e.g., front rail 50) may be frameworks of the rack 10 designed to support and secure electronic equipment within a rack 10. In an example, the rails may include robust materials such as but not limiting to steel or aluminum.

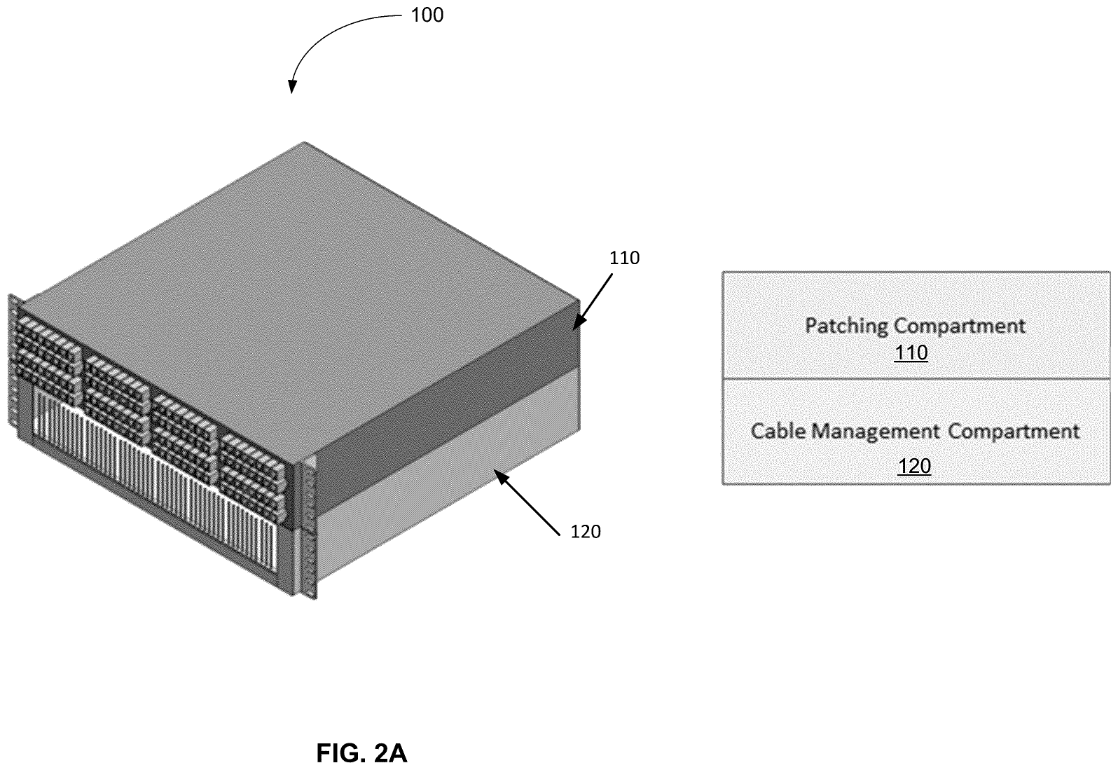

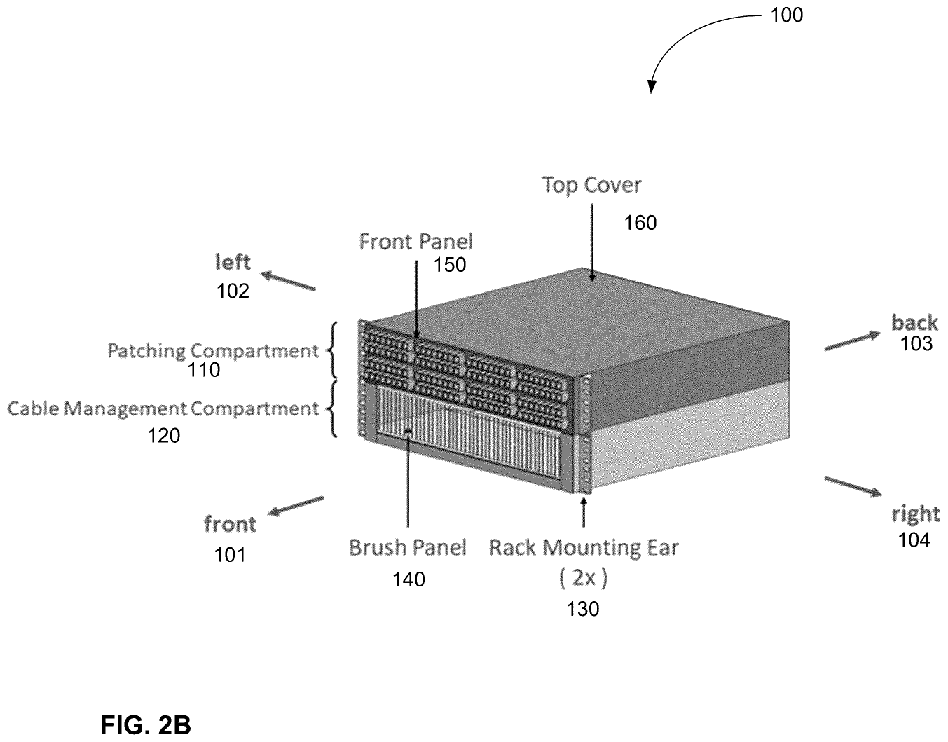

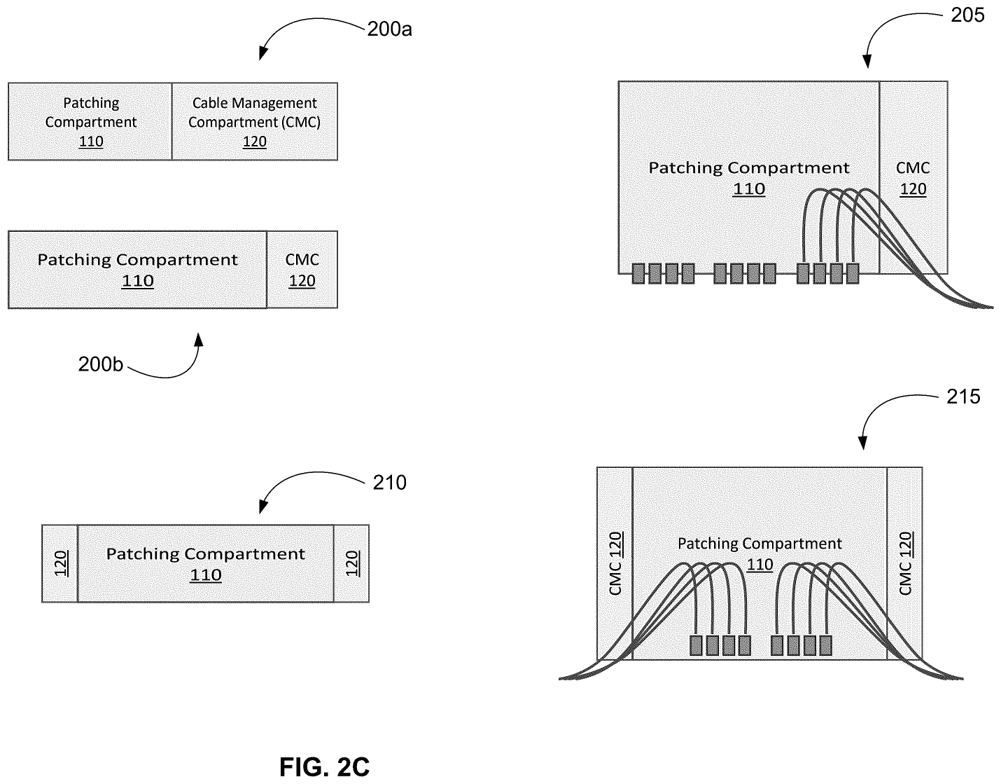

FIG. 2A illustrates an example fiber can 100, in accordance with an example of the present disclosure. The fiber can may be divided into two compartments, a patching compartment 110 and a cable management compartment 120. It is contemplated that the positioning of the patching compartment 110 and the cable management compartment 120 may be in any suitable arrangement, as illustrated in FIG. 2C, such that the number of optical cables may be accessed from the front of a rack (e.g., rack 10). In reference to FIG. 2B, the fiber can 100 may comprise 4 sides a denoted as front 101, left 102, back 103, and right 104, and a top cover 160 configured to house the cables utilized in the rack 10. Fiber can 100 may further comprise a front panel 150 associated with the patching compartment 110 and a brush panel associated with the cable management compartment 120. The fiber can 100 may be designed such that one or more fiber cans 100 may be utilized in a rack 10, wherein one or the one or more fiber cans 100 may be placed vertically on top, above, and/or below another fiber can 100. The fiber can may be designed to be connected or attached to rack 10 via a rack mounting ear 130 positioned on the left 102 and right 104 of fiber can 100, where the rack mounting cars 130 may be positioned towards the front 101 of fiber can 100. In some examples, the patching compartment 110 may be designed such that the compartment may be operated as a tray, e.g., the patching compartment 110 may be configured to slide out from of the body of fiber can 100. In some examples, patching compartment 110 may slide completely out of the body of fiber can 100 such that the patching compartment is separatable from the fiber can 100. In other examples, patching compartment 110 may be designed such that it may only slide out from fiber can 100 to a particular distance from the body of fiber can 100, e.g., the front panel 150 may extend to the front direction 101 until the length of patching compartment 110 is almost out of the body of fiber can 100. As such, the patching compartment 110 may comprise a stopping mechanism that prevents the patching compartment 110 from exiting or fully sliding out of fiber can 100. In reference to FIG. 2C, examples of alternative fiber can 100 compartments may be illustrated, it is understood that the FIG. 2C is merely an example, and there may be any number of suitable fiber can 100 compartments (e.g., patching compartment 110 and cable management compartment 120) positions. For example, fiber can 100 may comprise a patching compartment 110 positioned next to the cable management compartment 120, as illustrated from a front view 200a,b and a top view 205. In some examples, the size of the patching compartment 110 and the cable management compartment may be variable, for example the width of the patching compartment 110 may be larger than the width of the cable management compartment 120, as illustrated in front view 200b. In some examples, the width of the patching compartment 110 may be the same or similar to the width of the cable management compartment 120, as illustrated by in front view 200a. In some examples, the fiber can 100 may comprise a number of patching compartments (e.g., one or more patching compartments 110) or a number of cable management compartments (e.g., one or more cable management compartments 120). As illustrated in front view 210, a fiber can 100 may comprise two cable management compartments (e.g., cable management compartment 120), where one of the two cable management compartments is located on one side of the width of patching compartment 110, and the second of the two cable management compartments is located on the opposite side of the patching compartment 110. FIG. 2C may further illustrate a top view 215 of the fiber can 100 comprising two cable management compartments.

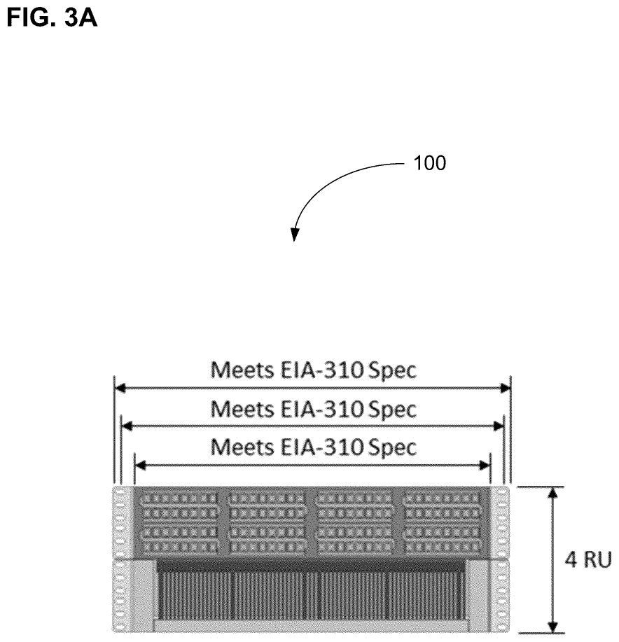

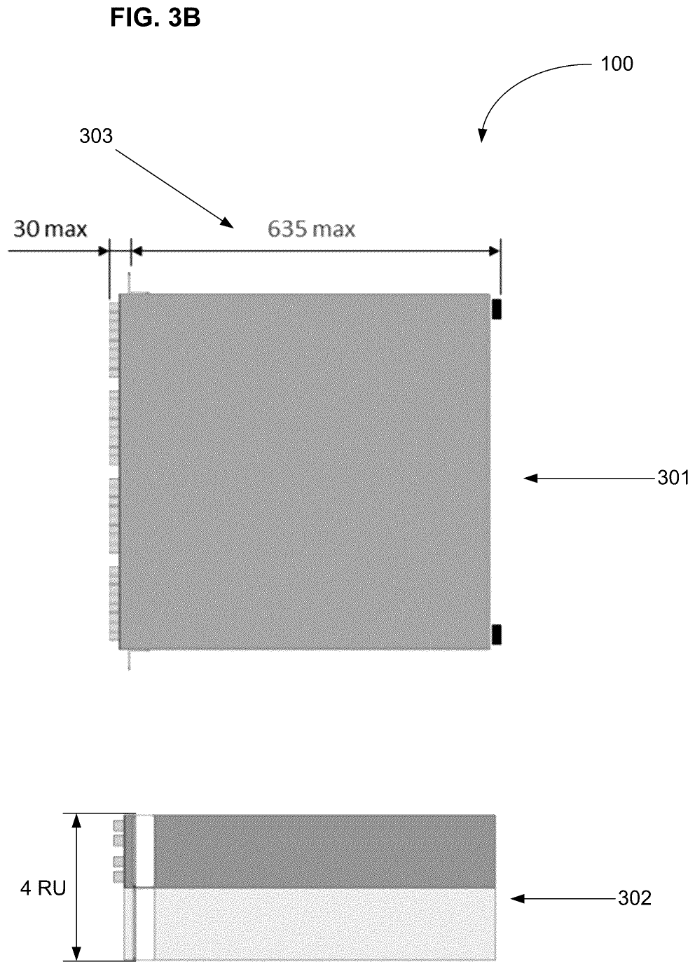

FIG. 3A illustrates example dimensions associated with a fiber can 100, in accordance with an example of the present disclosure. The view of FIG. 3A may be as if a user is looking directly at the front 101 of the fiber can 100. In an example and by no way of limitation, the fiber can 100 may be four rack units (RU) high, and meet the Electronic Industries Association (EIA) compliance standards in width associated with various lengths across the front 101 of the fiber can 100. For example, the length of the fiber can 100 may be EIA-310 compliant. It is contemplated that the fiber can dimensions illustrated may be of any suitable size to fit a rack, for example, the fiber can may be two RU high, one RU high, two rack open units (OU) high. 1 OU high, or any suitable dimension such that fiber can 100 may be utilized with a number of different types of racks.

Racks (e.g., rack 10) may be standardized to help unify the design and manufacturing of servers and networking equipment that are designed to be rack mounted, as such fiber can 100 may be designed such that it may fit any rack (e.g., rack 10) that meets EIA-310 compliance standards. EIA-310 is a specification for what is often called the “standard rack”. This specification standardizes several important features of 19″ racks, such as the RU, vertical hole spacing, horizontal hole spacing, rack opening, and front panel 150 width. The EIA-310 specification also sets tolerances on each of these dimensions. In an example, racks (e.g., rack 10) may be designed by height, measured in rack units (RU), wherein a RU may measure to 1.75 inches or 44.45 mm. In the example of 19″ racks, the 19″ may indicate or specify the width of the front panel 150 associated with the fiber can 100.

Now in reference to FIG. 3B, example dimensions associated with fiber can 100 may be further defined. As such the view of fiber can 100 may be in a side view 302 and top view 301 such that the example dimensions of fiber can 100 may be illustrated or defined. The dimensions of fiber can 100 may be EIA-310 compliant. Meaning that the fiber can mounting depth 303 may be defined as the dimension from the front 101 to the back 103 of the fiber can 100. The mounting depth 300 associated with fiber can 100 may be variable depending on the use of fiber can 100 and the rack 10 used.

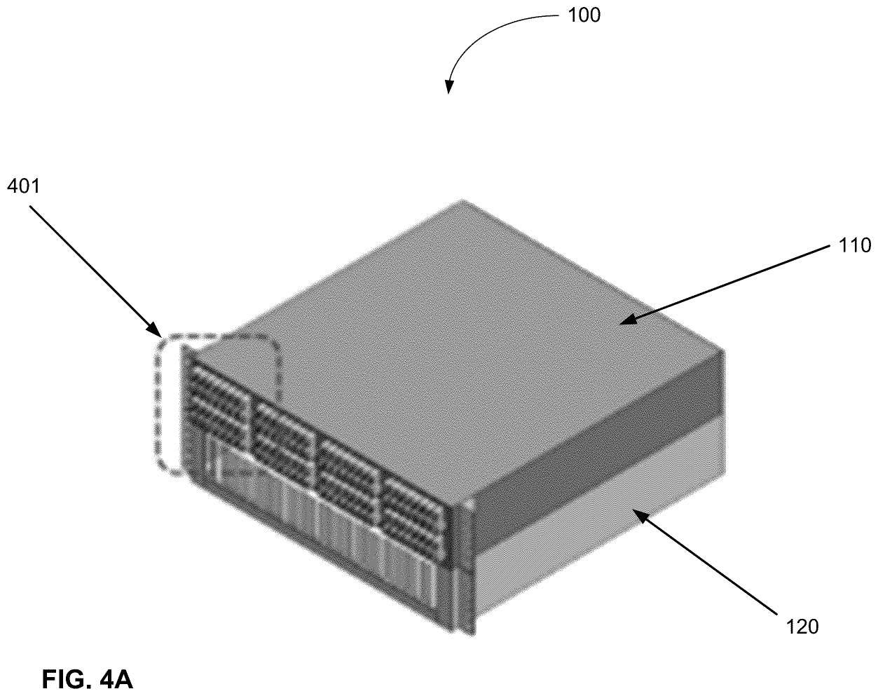

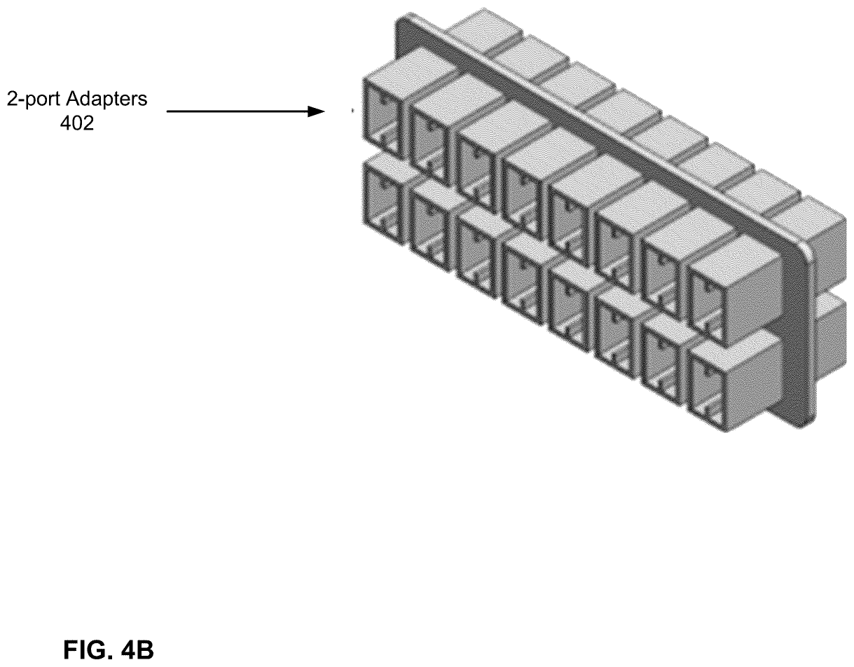

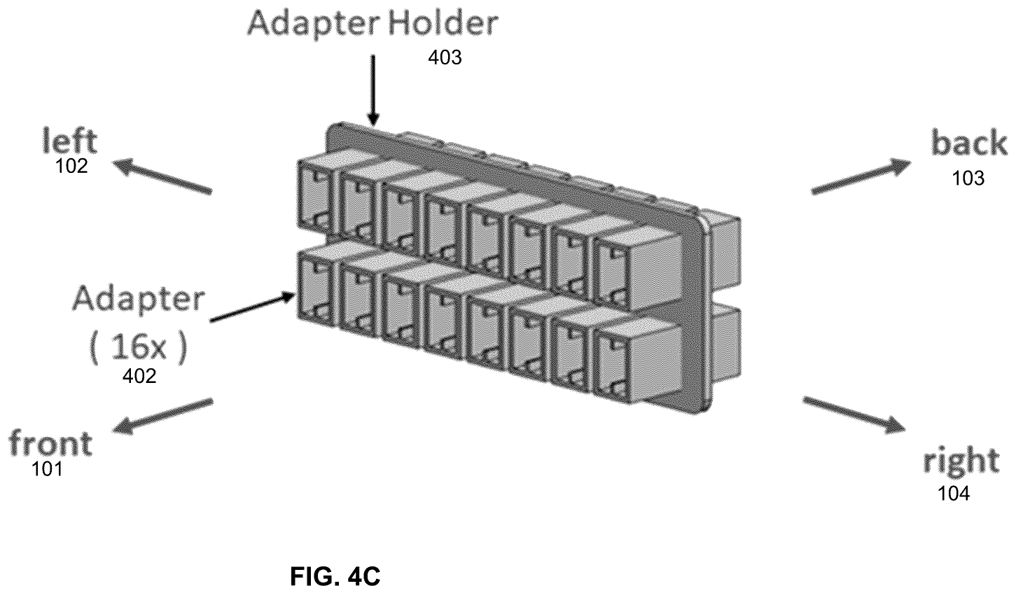

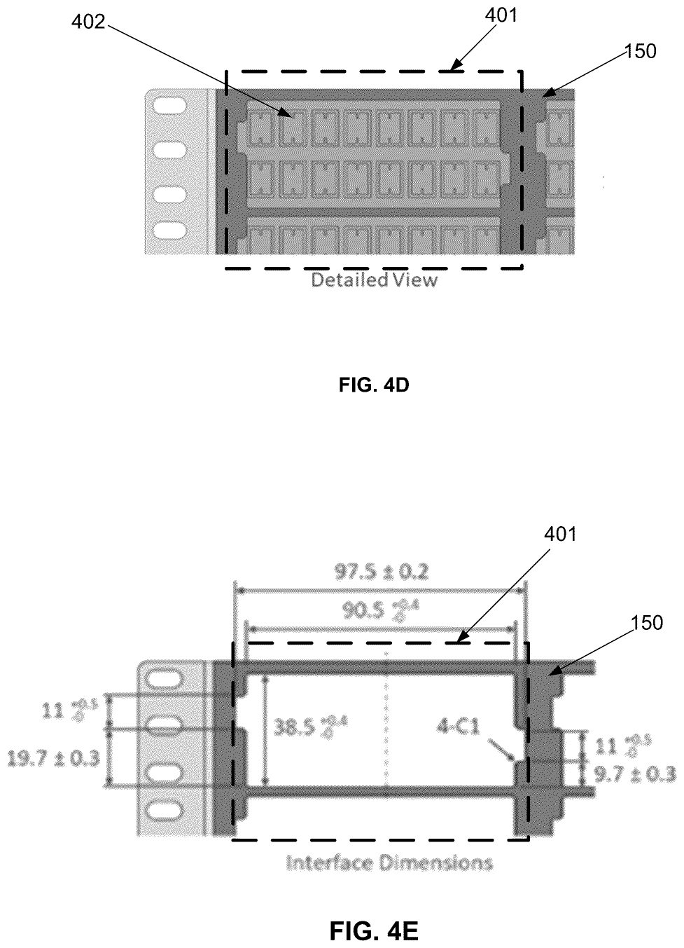

FIG. 4A illustrates a fiber can 100 with a circle focusing on one fiber access point (FAP) panel 401 of a number of FAP panels. The fiber can 100 may comprise a number of FAP panels (e.g., FAP panel 401) with consistent spacing between one or more FAP panels of the FAP panels of the number of FAP panels. The spacing between one or more FAP panels of the FAP panels may be adequate to allow cable installation and withdrawal from the FAP panels (e.g., FAP panel 401). In an example, the spacing between one or more FAP panels of the number of FAP panels may be configured to have sufficient enough space to allow for finger access in any direction associated with a user. For example, the spacing between the number of FAP panels may be 6.5 mm to allow for a user to interact with the front panel 150, for installation, insertion, or withdrawal of cables in association of a number of FAP panels. The FAP panel 401 may be exploded or zoomed in, in reference to FIG. 4B, illustrating that the FAP panel 401 may comprise a number of adapters 402, where one or more cables may be connected on the front 101 and back 103 side of the FAP panel 401. The adapters 402, as illustrated may be a two-port adapter, however it is contemplated that any suitable port-adapter may be utilized in FAP panel 401 such as but not limiting to, one-port adapters, two-port adapters, four-port adapters, or any combination thereof. As shown in FIG. 4C, the orientation and nomenclature in relation to the fiber can 100 may be shown. There may be any number of adapters, although for purpose of illustration, in FIG. 4C there may be 16 adapters 402 associated with one FAP panel 401. In an example, one or more FAP panels of the number of FAP panels may contain an array of adapters, wherein a dust cap may be utilized on an adapter 402 port associated with the array of adapters, when the adapter port is not in use. The adapters 402 may be held together, in place, or connected via an adapter holder 403. FIG. 4D may illustrate a more detailed view of FAP panel 401 in relation to the front panel 150. The FIG. 4E may illustrate some example dimensions of the front panel 150 with example dimensions in relation to FAP panel 401. The FAP panel 401 as shown in FIG. 4A may be held together with a number of other FAP panels, via a FAP holder sheet 404. For purpose of illustration the front panel 150 may comprise 8 FAP panels (e.g., 8 FAP panels 401). The FAP holder sheet 404 may be composed of metal or any other suitable material with a thickness of 1.5 millimeters (mm) or any other suitable thickness. The FAP holder sheet 404 may be configured or assembled to only allow a number of FAP panels (e.g., FAP panels 401) to be assembled from a first direction in a first orientation, to avoid misuse and confusion. For example, the two-port adapter 402 may have a first side and a second side, the FAP holder sheet 404 may only allow for FAP panels to have the first side protruding or sticking out from the front panel 150 of the fiber can 100.

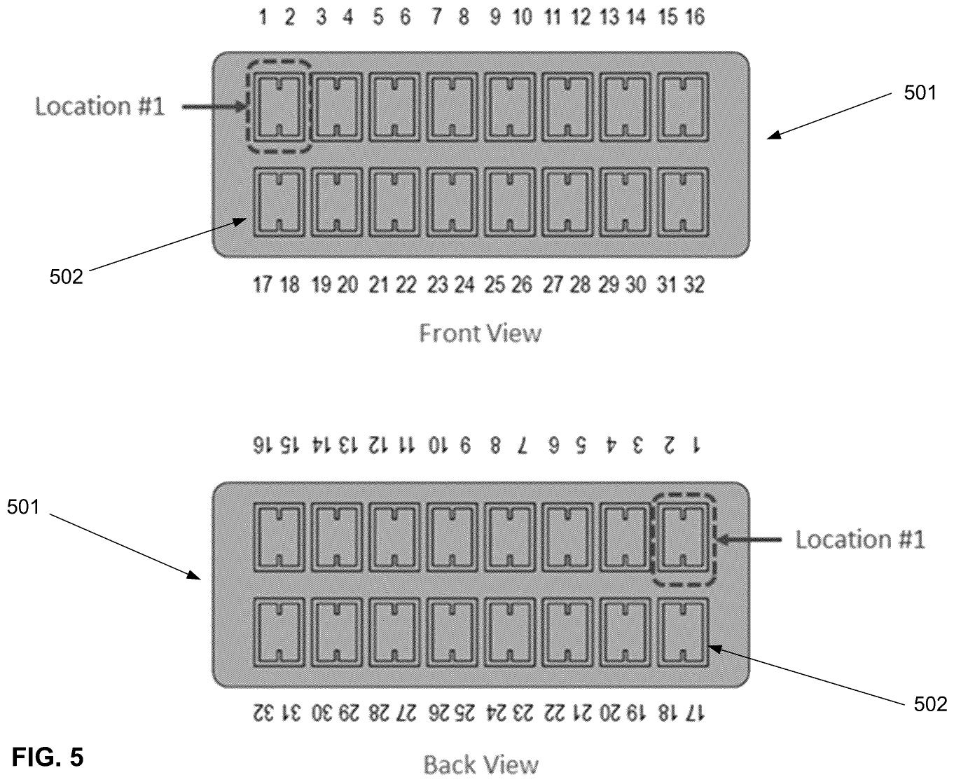

FIG. 5 illustrates an example FAP panel 501 (e.g., FAP panel 401) and FAP holder sheet 504 (e.g., FAP holder sheet 404) comprising an example port 1 location and two-port adapter 502 (e.g., two-port adapter 402) marking orientation. In an example, the two-port adapter 502 may be marked adequately and visibly from both the front 101 and back 103 sides of the FAP holder sheet 504 in relation to the front panel (e.g., front panel 150). As such, cable patching locations may be easily identified in data centers or any other applicable system. In an example, the marking and patching location may be consistent between front 101 and back 103 of the FAP holder sheet 504. In an example, the markings associated with the patching locations may be of one single color, such that it may be easy to discern the patching locations. For example, the markings may be white in color.

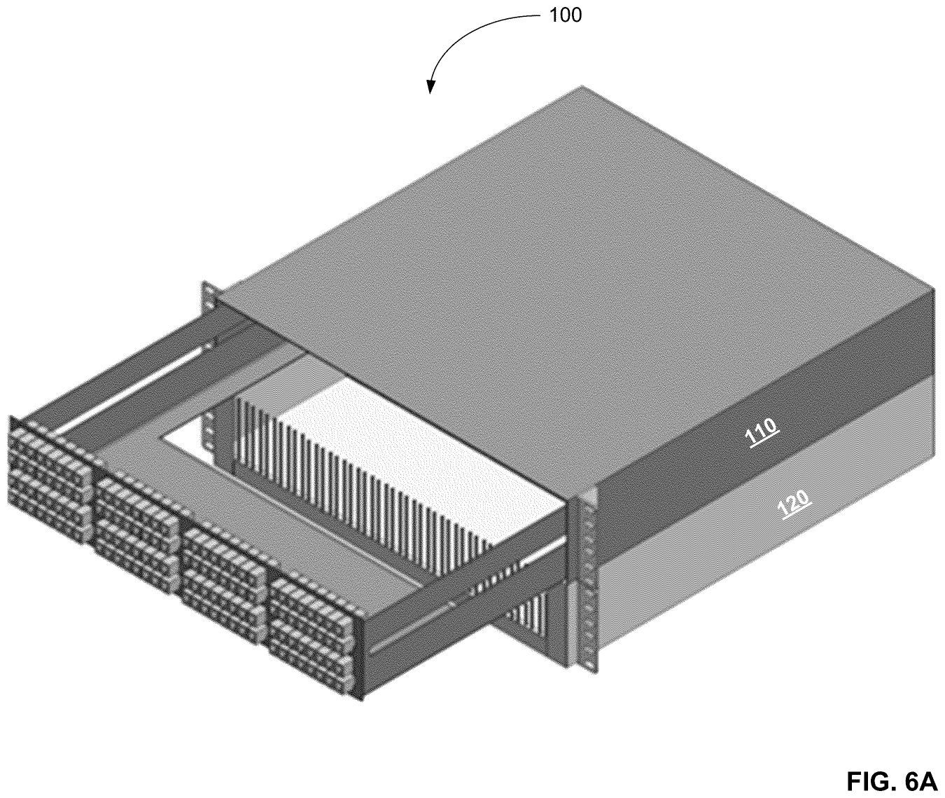

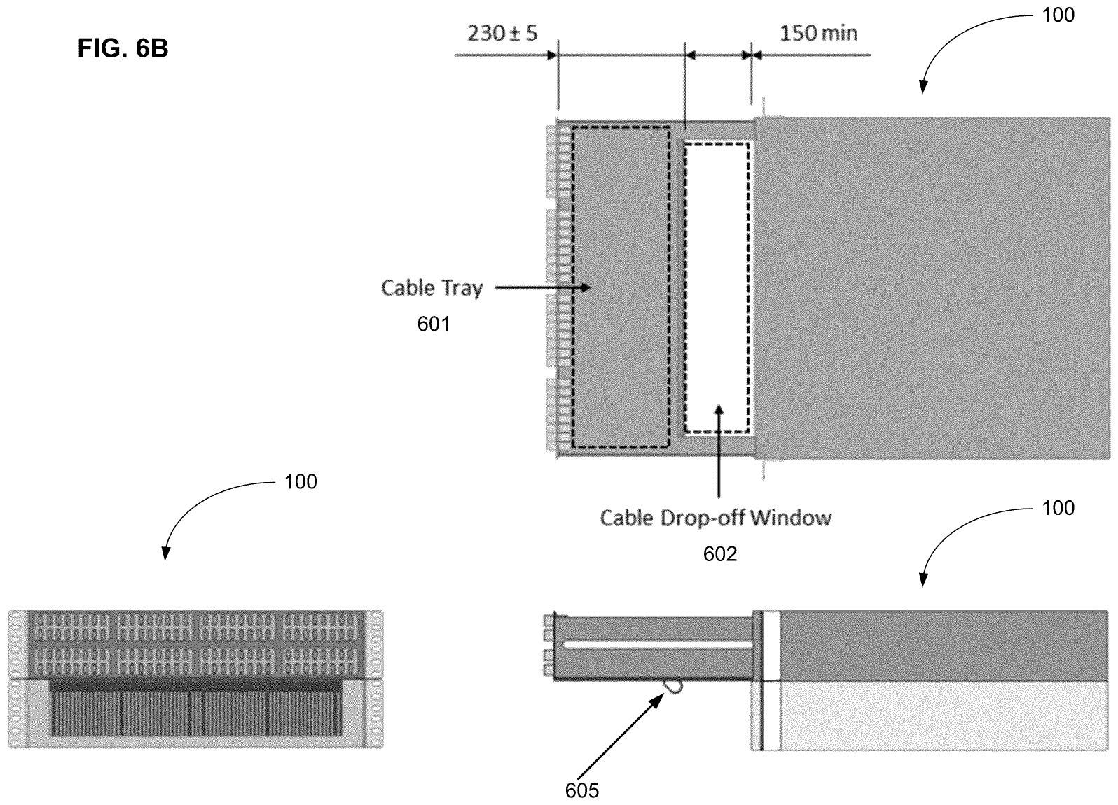

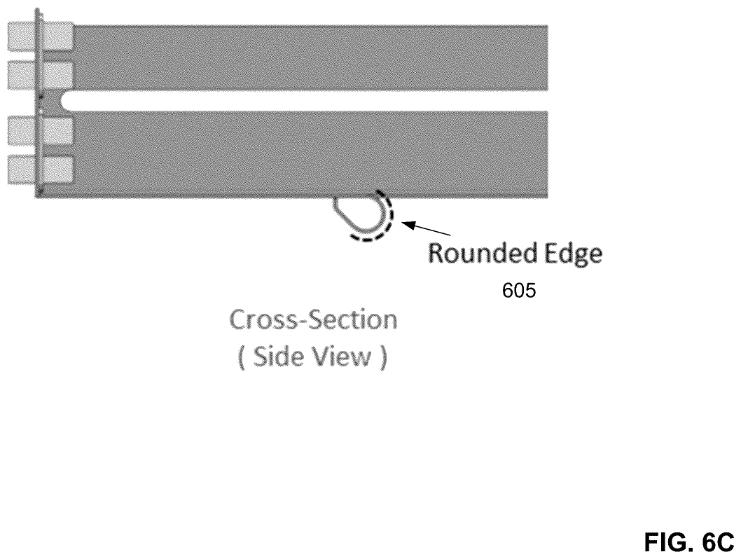

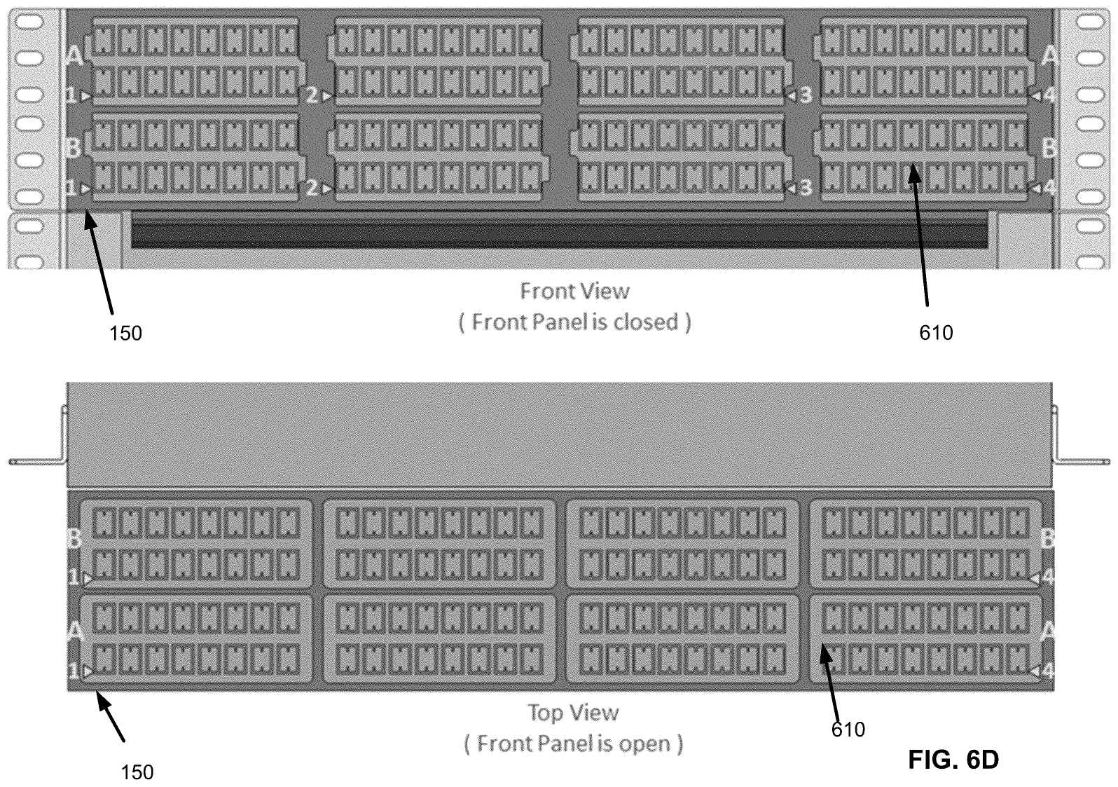

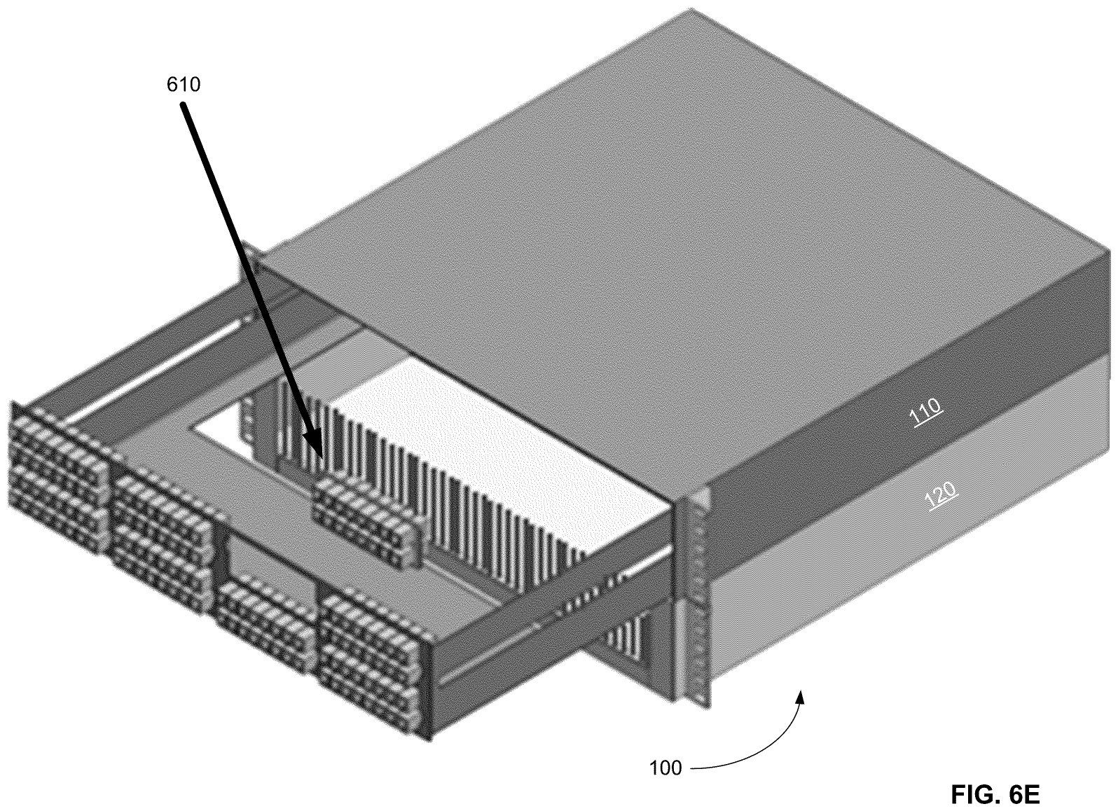

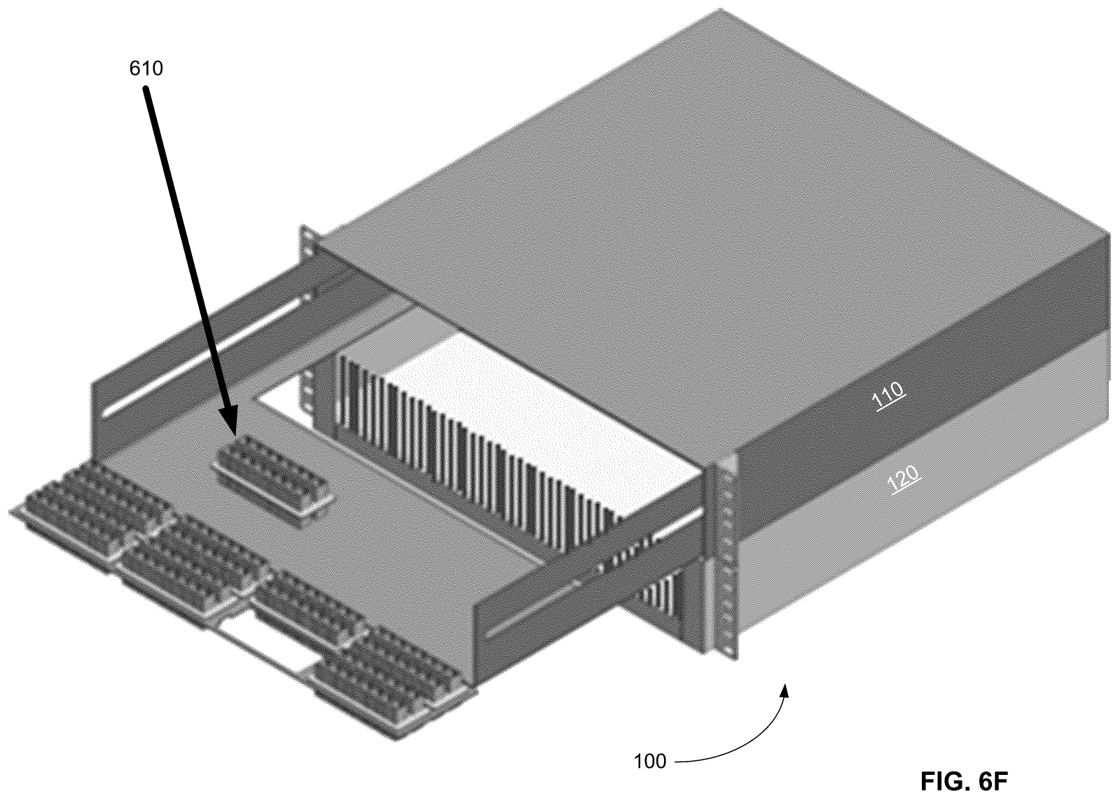

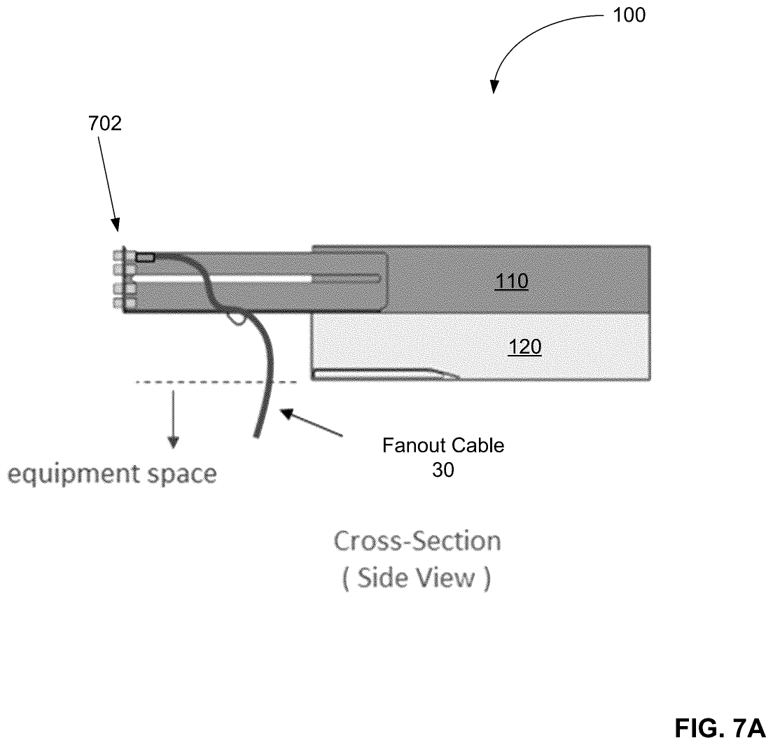

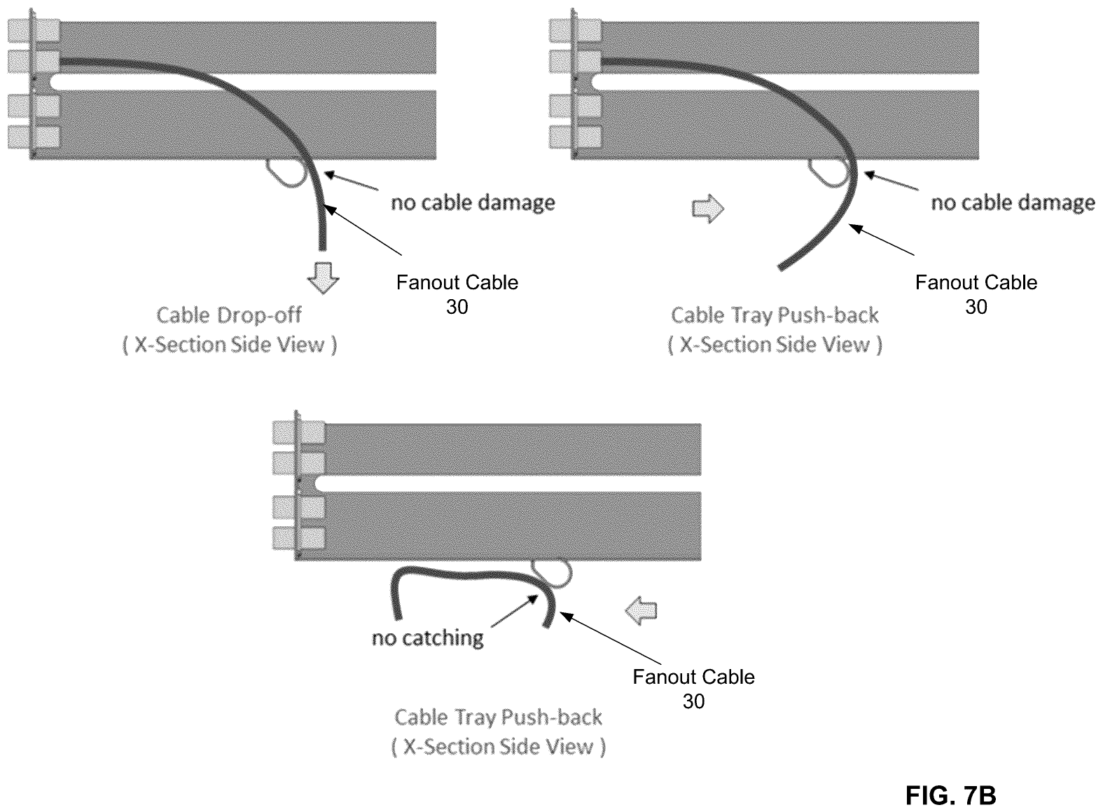

FIG. 6A illustrates an example fiber can 100 patching compartment 110. In an example, the patching compartment 110 may be configured such that the patching compartment 110 may operate like a drawer or tray. The patching compartment 110 may be pulled out from fiber can 100 horizontally with or without cables installed associated with the front panel 150. In an example, when the patching compartment 110 is pulled from fiber can 100 no actions may occur to the cable management compartment 120. The sliding of patching compartment 110 may allow for back 103 side patching and cable management properties, the sliding of the compartment may provide easy access to the back 103 of the front panel 150 comprising a number of adapters. The patching compartment 110 may also comprise a cable drop-off window 602 and a cable tray 601. The cable drop-off window 602 may be configured to allow cords to pass through the patching compartment 110 to the cable management compartment 120. FIG. 6B may illustrate some dimensions of the patching compartment 110 in a side view, front view, and a top view. In some examples, a FAP panel (e.g., FAP panel 401) may be configured to be removed or replaced in data centers, when necessary, without the need of tools and without operating the cable management compartment 120 from the rear side of the patch panel (e.g., front panel 150). The FIG. 6C may illustrate a rounded edge 605 associated with the cable drop-off window 602 and the rear edge of cable tray 601. The rounded edge may be configured to ensure cables are not damaged during cable management or patching compartment 110 movement. In an example, the rounded edge 605 may be designed geometrically such that the rounded edge 605 does not interact or catch on cables during patching compartment 110 movement, such as when the patching compartment 110 is pulled out from fiber can 100 or pushed into the body of fiber can 100. The rounded edge 605, may be further discussed in paragraphs associated with FIG. 7A and FIG. 7B. In some examples, the front panel 150 associated with the patching compartment 110 may be configured to be flipped down, as such a hinge or any other suitable engineering means may be utilized to provide a user a view of the back 103 of front panel 150 and a number of FAP panels 610. A front view (e.g., front panel 150 closed) and a top view (e.g., front panel 150 flipped down) of the front panel 150 may be illustrated in the FIG. 6D.

In some examples, any one of the number of FAP panels 610 (e.g., FAP panels 401) may be removed from the front panel 150 without the need for tools. This function may provide an easy method for removal and replacement of FAP panels 610 at datacenters or any other suitable environment. FIG. 6E and FIG. 6F may illustrate the ability of removing a FAP panel 610 when the front panel 150 may be closed or flipped down. In an example, when the front panel 150 is flipped down, a user may have easier access to the back 103 of the number of adapters (e.g., one-port adapter, two-port adapter 402, four-port adapter, or any combination thereof) associated with a number of FAP panels 610.

FIG. 7A illustrates a cross sectional side view of a fiber can 100 illustrating an example operation method of a patching compartment 110. In an example a second set of optical cables 30 may be attached to a second side (e.g., back 103 side) of a two-port adapter 702. As such, the second set of optical cables 30 (e.g., in-rack cable) may fall or be fed through the cable drop-off window (e.g., cable drop-off window 602) when the patching compartment 110 may be pulled out from fiber can 100. The FIG. 7B may illustrate cable (a second set of optical cables 30) interaction with the cable-drop off window (e.g., cable drop-off window 602). As illustrated, if the patching compartment is pushed-back to the back 103 of fiber can 100 or pulled out to the front 101 of fiber can 100 the cable does not bend enough to incur damage or catch other cables that may reside in the cable management compartment 120. In some examples, patching compartment 110 may comprise a locking mechanism to hold patching compartment 110 onto fiber can 100 and or cable management compartment 120. In some examples, the outer case (e.g., top cover 160) of patching compartment 110 may be flat and smooth. In an example, patching compartment may be designed to not have any sharp edges that may cause injury or cable damage.

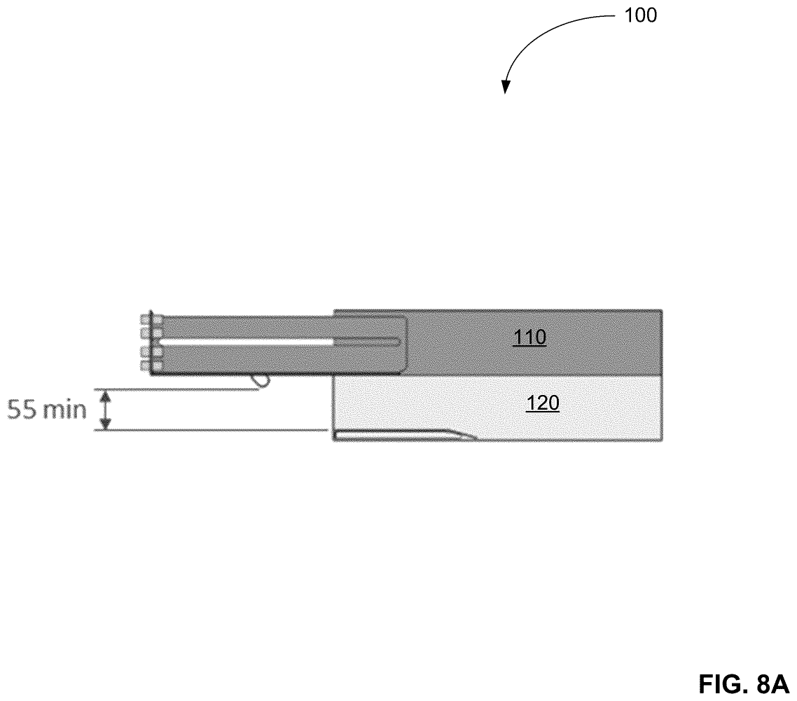

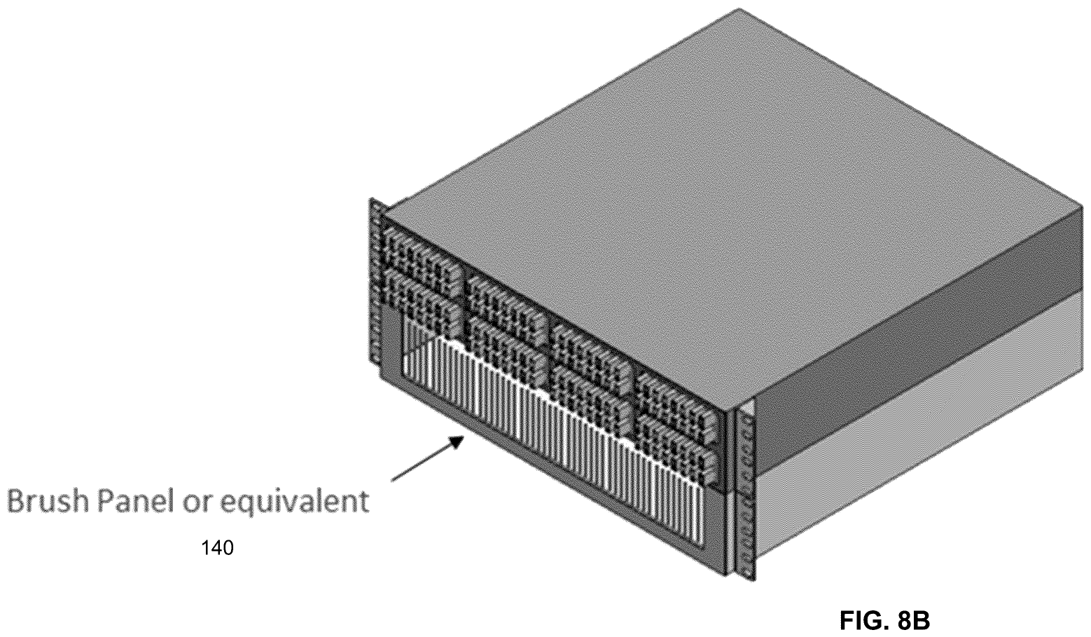

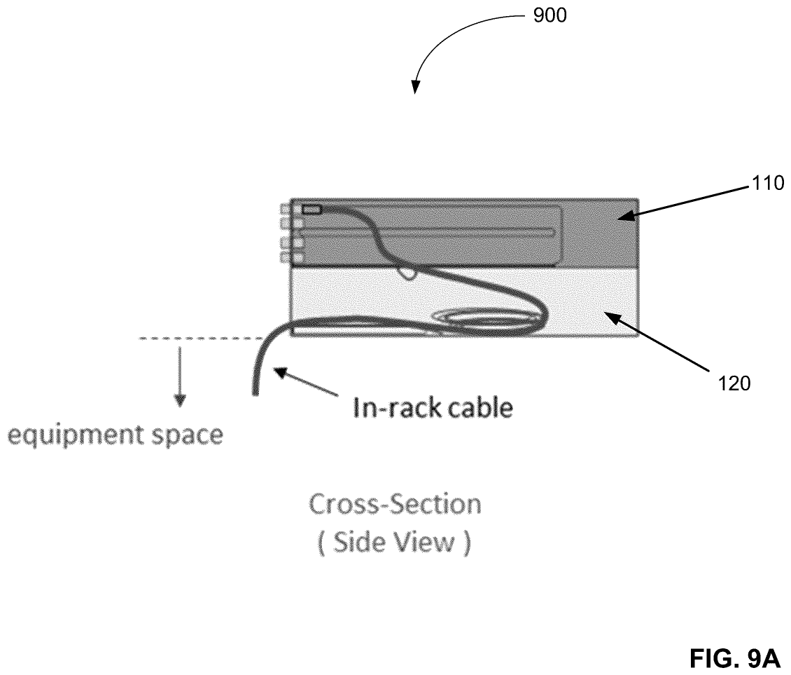

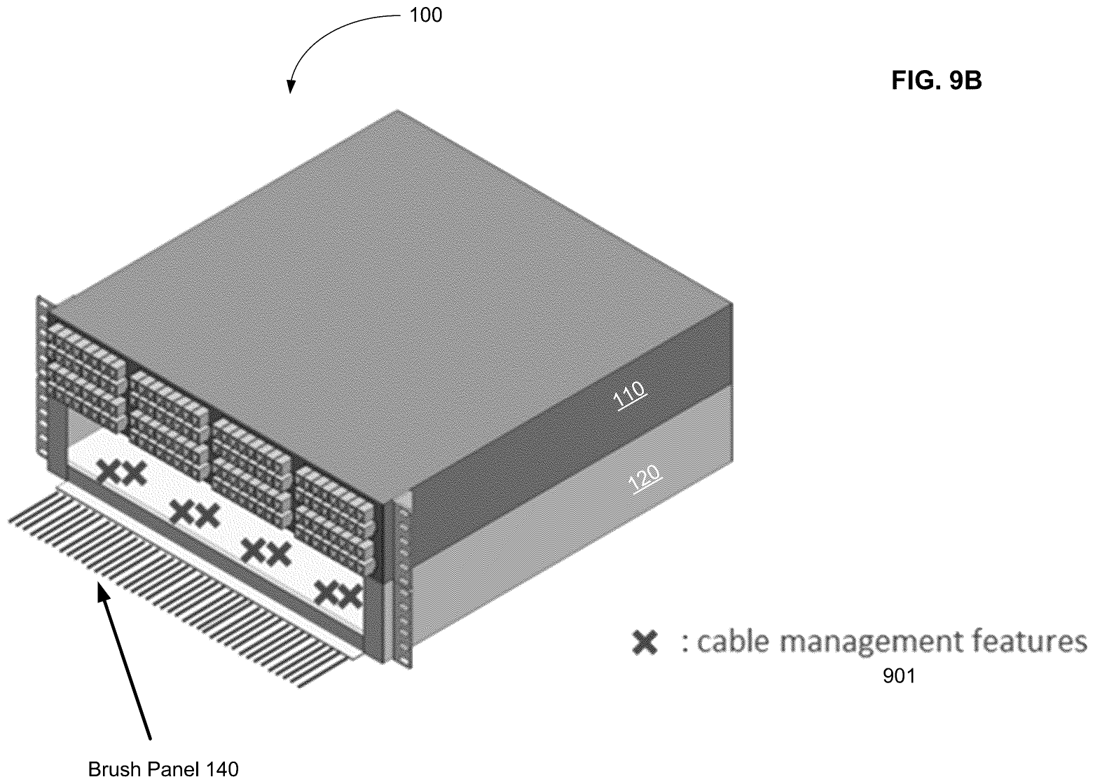

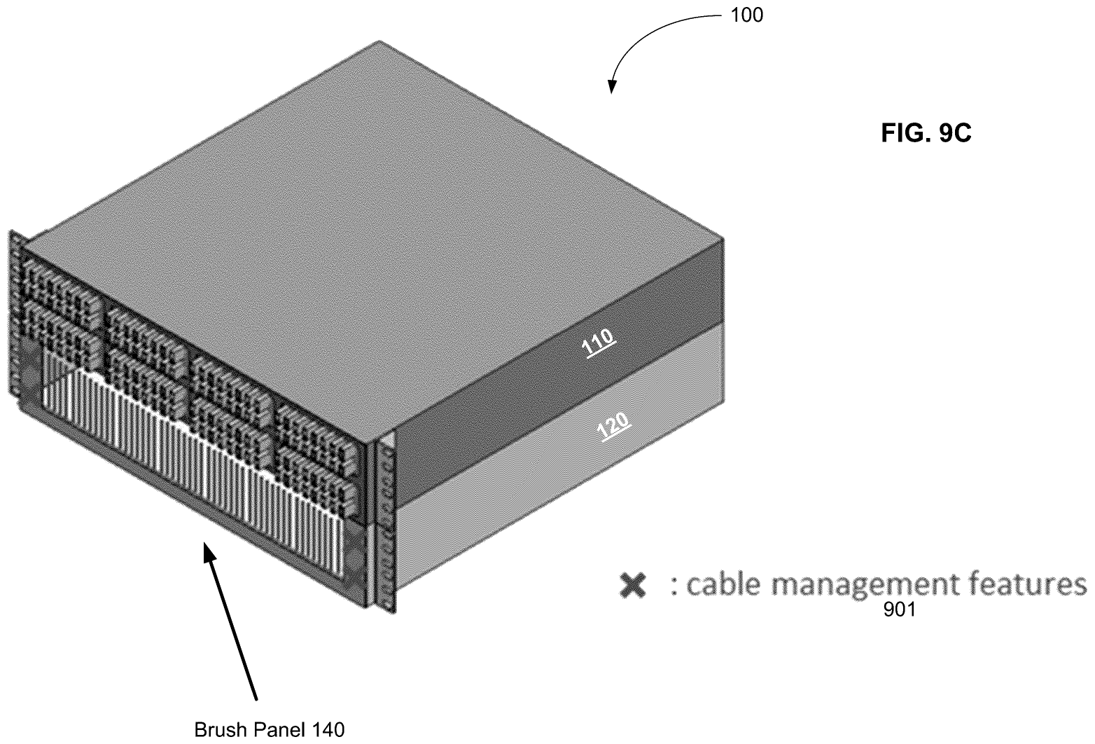

FIG. 8A illustrates example dimensions of a cable management compartment 120 associated with a cross sectional side view of a fiber can 100. The cable management compartment 120 may be configured to guide a set of optical cables (e.g., the second set of optical cables 30) to one or more switches 20 associated with a rack 10. In an example, the height of the cable management compartment may be 55 mm. The cable management compartment 120 may be configured for cable management and cable aggregation/dispersion space in association with the fiber can 100. In some examples, the cable management compartment 120 may comprise a brush panel 140 on the front 101 side of fiber can 100. In an example, at least 256 24f cables, each at least 1.5 meters long may be dropped off from the patching compartment 110 to the cable management compartment 120. As such, one or more cables of a number of cables may be managed in the cable management compartment 120 then exit the fiber can 100 and enter equipment space in the rack 10. Brush panel 140 may be configured to cover a front 101 opening of cable management compartment, wherein brush panel 140 may be configured to guide cables to enter or exit fiber can 100. With or without installed cables, brush panel 140 may be easily opened or closed without the need for tools, without operating patching compartment 110. In some examples, brush panel 140 may be configured to stay open, when opened, to allow maximum access to cables in cable management compartment as shown in FIG. 9B. In an example, the orientation of brush panel 140, e.g., closed or flipped down, may not interfere with the equipment, panel, cables installed in the rack unit below (e.g., another fiber can 100). Although, brush panel 140 may be specifically mentioned, the brush panel 140 may be any suitable method to allow for cables to organize and pass through the front 101 of cable management compartment 120. In some examples, brush panel 140 may comprise locking mechanisms to hold brush panel 140 onto cable management compartment 120. The locking mechanism may allow for easy transportation of a fiber can without the use of tools.

FIG. 9A illustrates an example cable 900 installation and positioning in a cable management compartment 120 of a fiber can. Now in reference to FIG. 9B. The FIG. 9B illustrates example cable management features 901 associated with a cable management compartment 120 of a fiber can 100. Cable management features may comprise Velcro, zip ties, or any other suitable method to manage cables. In an example, cable management features 901 may be located inside and close to the exit of the cable management compartment 120, e.g., front 101 opening. Cable management features 901 may be spaced adequately to allow cable management. For example, cables may be routed and managed successfully in the following ways, without damaging and causing performance issues; cables are routed to one side (e.g., left 102 or right 104) to enter the next cable management space, or half the cables are routed to one side (e.g., left 102) and the other half of cables are routed to the other side (e.g., right 104) to enter the next cable management space.

In some examples, cable management features 901 may be positioned outside of the exit of the cable management compartment 120 (e.g., outside of brush panel 140), as illustrated in FIG. 9C. In such an example, cables may be routed and managed successfully similar to the methods described with the FIG. 9B without damaging cables or causing performance issues. In some examples, cable management features 901 may be installed around the front opening of the cable management compartment 120 to prevent damage during cable management and cable dressing.

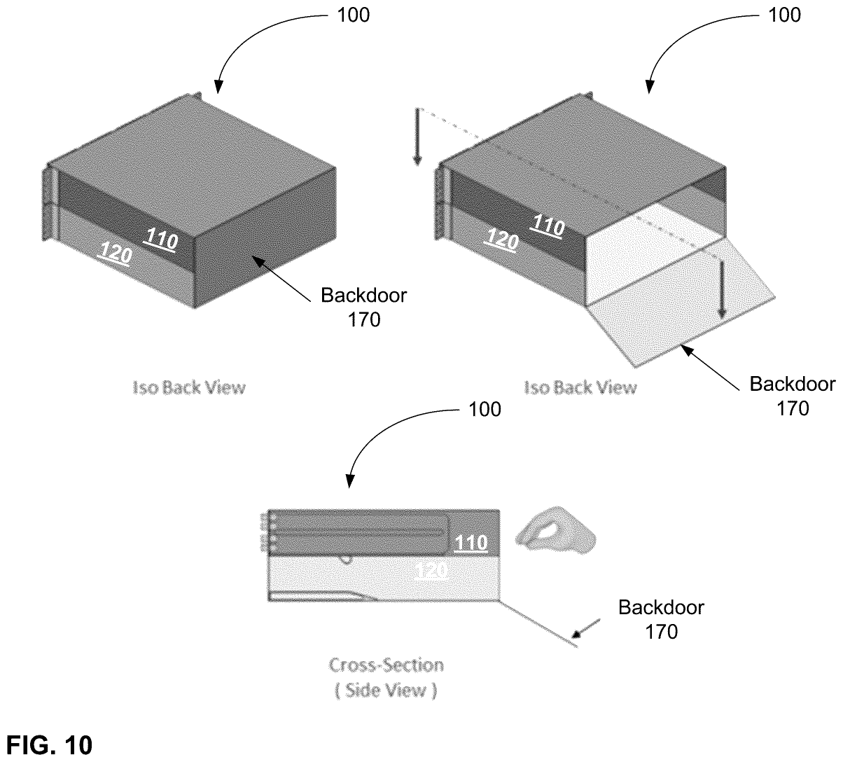

FIG. 10 illustrates an example fiber can 100. In some alternate examples, the fiber can 100 may comprise a backdoor 170. The backdoor 170 may be configured to provide an opening for a user to aid in cable management from the back 103 side of the fiber can 100. In some examples, a user may be able to maximally utilize the cable management compartment 120 from the backdoor 170. In some examples, the backdoor 170 may comprise a locking mechanism to hold backdoor 170 securely to fiber can 100, such that fiber can 100 may meet transportation and operation mechanical requirements and standardization from the EIA associated with fiber cans. As a result, fiber can 100 may be installed on stationary or transportable racks (e.g., racks 10).

It is to be appreciated that examples of the methods and apparatuses described herein are not limited in application to the details of construction and the arrangement of components set forth in the following description or illustrated in the accompanying drawings. The methods and apparatuses are capable of implementation in other examples and of being practiced or of being carried out or conducted in various ways. Examples of specific implementations are provided herein for illustrative purposes only and are not intended to be limiting. In particular, acts, elements and features described in connection with any one or more examples are not intended to be excluded from a similar role in any other examples.

It is to be understood that the methods and systems described herein are not limited to specific methods, specific components, or to particular implementations. It is also to be understood that the terminology used herein is for the purpose of describing particular examples only and is not intended to be limiting.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The foregoing description of the examples has been presented for the purpose of illustration; it is not intended to be exhaustive or to limit the patent rights to the precise forms disclosed. Persons skilled in the relevant art can appreciate that many modifications and variations are possible in light of the disclosure.

The scope of this disclosure encompasses all changes, substitutions, variations, alterations, and modifications to the example examples described or illustrated herein that a person having ordinary skill in the art would comprehend. The scope of this disclosure is not limited to the example examples described or illustrated herein. Moreover, although this disclosure describes and illustrates respective examples herein as including particular components, elements, feature, functions, operations, or steps, any of these examples may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular examples as providing particular advantages, particular examples may provide none, some, or all of these advantages.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the examples is intended to be illustrative, but not limiting, of the scope of the patent rights, which is set forth in the following claims.

What is claimed:

1. A rack comprising:
a fiber can, wherein the fiber can comprises;
a patching compartment;
a cable management compartment; and
a rail, wherein the rail is positioned towards a front side of the rack; and
a number of optical cables configured to attach to a patch panel.

2. The rack of claim 1, wherein the fiber can comprises four sides, a top cover, and rack mounting ears.

3. The rack of claim 1, wherein the fiber can is mounted to the rack via rack mounting ears.

4. The rack of claim 1, wherein the patching compartment comprises a front panel, a cable drop-off window, and a rounded edge.

5. The rack of claim 4, wherein the front panel comprises a plurality of fiber access point panels, wherein one or more fiber access point panels of the plurality of fiber access point panels comprises a plurality of adapters held together by an adapter holder.

6. The rack of claim 5, wherein the plurality of fiber access point panels are held together via a fiber access point holder sheet.

7. The rack of claim 4, wherein the plurality of fiber access point panels comprises a plurality of adapters configured as components of the patch panel.

8. The rack of claim 1, wherein the patch panel is configured to create connections between a plurality of cables.

9. The rack of claim 1, wherein the patching compartment is configured to slide out of the fiber can and is positioned above the cable management compartment.

10. The rack of claim 1, wherein the cable management compartment comprises a brush panel and one or more cable management features.

11. The rack of claim 1, wherein the cable management compartment directs a second set of optical cables to the rail of the rack.

12. The rack of claim 1, comprising:
a switch or a power module configured to receive a plurality of cables from the patch panel.
